(19) United States
(12) Patent Application Publication
(10) Pub. No.: US 2003/0204612 A1
(43) Pub. Date: Oct. 30, 2003

(54) System and method for facilitating device communication, management and control in a network

(76) Inventor: Mark Warren, Highland Village, TX (US)

Correspondence Address: BELL, BOYD & LLOYD, LLC, PO BOX 1135, CHICAGO, IL, 60690-1135, US

(21) Appl. No.: 10/136,142

(22) Filed: Apr. 30, 2002

(51) Int. Cl. G06F 15/16; G06F 3/00

(52) U.S. Cl. 709/230; 710/11

(57) ABSTRACT

An apparatus for facilitating communication in a network includes a web services interface operable to communicate over a network and receive a command using a web services protocol. The apparatus also includes a command translator operable to receive the command and generate at least one device command corresponding to the command. The at least one device command is operable to invoke one or more functions in at least one network element. The apparatus further includes a plurality of protocol converters each operable to receive at least one device command, translate the at least one device command from a first protocol to a second protocol, and communicate the at least one device command to one or more network elements. At least two of the protocol converters are operable to translate the at least one device command into different second protocols.

### BACKGROUND OF THE INVENTION

1. Technical Field

This invention relates generally to communication systems, and more particularly to a system and method for facilitating the communication, management and control of devices in a network environment.

2. Background

A communications network often includes different elements, such as servers and routers, which perform various functions in the network. In addition, elements not directly related to the communication function of the network may be connected and available to perform a variety of tasks. These elements often have different management and control interfaces, and use different protocols to communicate. Elements that perform similar network and non-network functions may also be manufactured by different vendors, and even these elements routinely have different management interfaces and use different communications protocols. As a result, one element may need to support multiple communications protocols to communicate with, manage, or control other elements in the network.

### SUMMARY OF THE INVENTION

The present invention recognizes a need for an improved system and method for facilitating device communication, management and control in a network, which reduce or eliminate at least some of the problems and disadvantages associated with prior systems and methods.

In one embodiment of the invention, an apparatus for facilitating communication, management and control in a network includes a web services interface operable to communicate over a network and receive commands using a web services technology. The apparatus also includes a command translator operable to receive the command and generate at least one device command corresponding to the command received. The at least one device command is operable to invoke one or more functions in at least one network or non-network device element. The apparatus further includes a plurality of protocol converters, each operable to receive at least one device command, translate the at least one device command from a first protocol to a second protocol, and communicate the at least one device command to one or more network or non-network device elements. At least two of the protocol converters are operable to translate the at least one device command into different second protocols.

Numerous technical advantages can be gained through various embodiments of the invention. Various embodiments of the invention may exhibit none, some, or all of the following advantages depending on the particular implementation and features selected. For example, in one embodiment, a system for facilitating communication in a network is provided. In particular, an abstraction apparatus is provided that facilitates communication with network elements that use different communications protocols. The apparatus may receive a command from a first network element in a first protocol and translate the command into one or more commands in a second protocol used by a second network element. This may allow, for example, a network manager to communicate with a wide variety of managed elements in the network, even when the managed elements use different protocols. This may also reduce the complexity of the network manager because the manager may not need to support every protocol used by a managed element in the network.

Another advantage of at least some embodiments of the invention is that the abstraction apparatus may receive commands from a network element using a web services protocol, such as the SOAP protocol. In a particular embodiment, the abstraction apparatus communicates with a network manager using the web services protocol. This may allow, for example, a managed element in the network to be treated as a web service. This may also simplify the management of network or non-network device elements and facilitate easier management of the devices that are connected or comprise the network.

In addition, at least some embodiments of the invention allow for end-to-end provisioning and management of the network, as well as non-network connected devices. For example, in a particular embodiment, managed network or non-network device elements may reside in a customer's network, and a network manager may be used by a service provider. In this embodiment, the customer and/or service provider may use the abstraction apparatus to allow the manager to manage and control elements in the customer's network as well as in the service provider's network. This may help to increase the efficiency of managing the network and all connected devices.

Other technical advantages will be readily apparent to one of skill in the art from the attached figures, description, and claims.

Additional features and advantages of the present invention are described in, and will be apparent from, the following Detailed Description of the Invention and the figures.

### BRIEF DESCRIPTION OF THE FIGURES

For a more complete understanding of the present invention and the features and advantages thereof, reference is now made to the following descriptions taken in connection with the accompanying drawings, in which:

FIG. 1 illustrates an example communications system constructed according to the teachings of the present invention;

FIG. 2 illustrates an example abstraction device constructed according to the teachings of the present invention;

FIG. 3 illustrates an example network command according to the teachings of the present invention;

FIG. 4 illustrates an example method for facilitating communication with network elements according to the teachings of the present invention;

FIG. 5 illustrates an example method for managing a transaction according to the teachings of the present invention; and

FIG. 6 illustrates an example method for facilitating communication with a manager according to the teachings of the present invention.

### DETAILED DESCRIPTION OF THE INVENTION

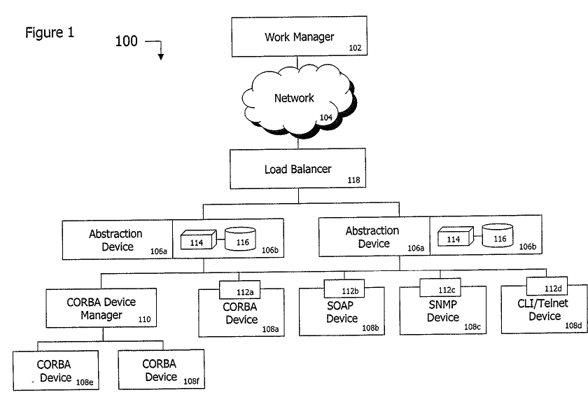

FIG. 1 illustrates an example communications system 100 constructed according to the teachings of the present invention. In the illustrated embodiment, system 100 includes a work manager 102, a network 104, one or more abstraction devices 106a-106b (referred to collectively as abstraction devices 106), and one or more network elements 108a-108f (referred to collectively as network elements 108). Other embodiments of system 100 may be used without departing from the scope of the present invention.

In one aspect of operation, an abstraction device 106 facilitates communication with one or more network elements 108 in system 100. For example, abstraction device 106 may allow manager 102 to communicate and exchange information with a network element 108 when manager 102 and network element 108 use different communications protocols. In this embodiment, abstraction device 106 may perform a translation function to translate between the protocol used by manager 102 and one or more protocols used by network elements 108. In a particular embodiment, manager 102 communicates using a web services protocol, and abstraction device 106 translates between the web services protocol and the protocols used by network elements 108. This may allow manager 102 to communicate with different network elements 108 using a common protocol. This may also reduce the complexity of manager 102 and/or other components of system 100 because those components need not support every protocol used by network elements 108. In addition, the use of abstraction device 106 may allow for greater flexibility in managing system 100.

Manager 102 is coupled to network 104. In this document, the term “couple” refers to any direct or indirect communication between two or more elements, whether or not those elements are in physical contact with one another. Manager 102 may perform any suitable management operations in system 100. For example, manager 102 may provision and manage network elements 108 in system 100, such as by instructing a network element 108 to operate using a specified set of operating parameters. As a particular example, manager 102 may instruct a network element 108 to set up a virtual private network for a customer of a service provider operating manager 102.

Manager 102 may issue any suitable commands to one or more network elements 108 in order to provide the desired functionality. In one embodiment, manager 102 may issue commands causing one or more network elements 108 to provision, build, configure, rebuild, and/or reconfigure one or more services for a user of system 100. Manager 102 could also issue commands causing a network element 108 to monitor its operational performance or perform a self-diagnostic. Manager 102 may support any other and/or additional commands without departing from the scope of the present invention.

Manager 102 may also store information about network elements 108 and/or other components of system 100. For example, manager 102 may store information identifying incidents or alarms originating from a network element 108. Manager 102 may also store information identifying the operational performance of a network element 108, and manager 102 or other element of system 100 may use this information to identify problems in system 100. Manager 102 may store any other and/or additional information without departing from the scope of the present invention.

In one embodiment, manager 102 communicates with network elements 108 using one or more web services protocols. A web service may represent a programmable application that may be available for use over a network, such as the Internet. A web services protocol is a protocol that may allow a web service to be published, located, and invoked over a network, although any other and/or additional functions may be supported by the web services protocol. For example, the web services protocol may be used to inform users and other web services how commands should be formatted to invoke the web service. In this embodiment, a network element 108 may be treated as a web service. In this manner, functions of the network element 108 may be published, located, and invoked over network 104. In this embodiment, the web services protocol may describe how to access and invoke functions of the network element 108.

In a particular embodiment, manager 102 communicates commands over network 104 using the web services protocol standard. The web services protocol standard supports the communication of extensible Markup Language (XML) encoded information using the HyperText Transfer Protocol (HTTP). In this embodiment, XML documents containing the commands may be communicated over a Simple Object Access Protocol (SOAP) interface. Also, in this embodiment, the communication and routing of the XML documents may be managed using BIZTALK ORCHESTRATION by MICROSOFT CORPORATION or other workflow management technologies from other software technology vendors. Other web services protocols, interfaces, and/or management techniques may be used without departing from the scope of the present invention.

Manager 102 may include any hardware, software, firmware, or combination thereof for performing one or more management operations. In one embodiment, manager 102 includes one or more processors operable to execute one or more software routines.

Network 104 facilitates communication between manager 102 and network elements 108. Network 104 may, for example, communicate Internet Protocol (IP) packets, frame relay frames, Asynchronous Transfer Mode (ATM) cells, and/or other suitable information between network addresses. Network 104 may include one or more local area networks (LANs), metropolitan area networks (MANs), wide area networks (WANs), all or a portion of the global computer network known as the Internet, and/or any other communications system or systems at one or more locations.

Abstraction device 106 is coupled to network 104. Abstraction device 106 may also be coupled to one or more network elements 108. Abstraction device 106 may be coupled to a network element 108 directly, indirectly through a device manager 110 or other component, or in any other suitable manner. Abstraction device 106 facilitates communication between manager 102 and network elements 108. Abstraction device 106 may, for example, receive a command from manager 102, translate the command from the protocol used by manager 102 into another protocol, and communicate the translated command to one or more network elements 108. In a particular embodiment, manager 102 communicates using a web services protocol, and abstraction device 106 translates between the web services protocol used by manager 102 and the protocols used by network elements 108. Abstraction device 106 may also receive information such as an alarm from a network element 108, translate the information into a format that can be understood by manager 102, and communicate the information to manager 102. Depending on the implementation, abstraction device 106 could facilitate unidirectional or bidirectional communication between manager 102 and a network element 108.

In one embodiment, abstraction device 106 may also perform transaction management functions. In this document, the term “transaction” refers to a sequence of one or more commands. In a particular embodiment, each command in a transaction should execute successfully before the transaction may complete successfully. In this document, the term “each” refers to each of at least a subset of the identified items. As an example, a bill payment transaction may involve two steps, debiting the debtor's account and crediting the creditor's account. Both steps should be completed successfully before the transaction is completed. The debtor does not want his or her account debited if the creditor's account cannot be credited by the same amount. In this embodiment, abstraction device 106 may monitor a transaction and ensure that each command in the transaction completes successfully.

If one or more of the commands in a transaction do not complete successfully, abstraction device 106 may instruct at least one network element 108 to “roll back,” or return to the state the network element 108 was in before the beginning of the transaction. For example, in the bill payment transaction, a first network element 108 may successfully debit the debtor's account, while a second network element 108 unsuccessfully attempts to credit the creditor's account. In that case, the first network element 108 should return the debtor's account to its original state before the debit occurred. This returns the network elements 108 to the state they were in before the bill payment transaction began.

In one embodiment, a network element 108 may or may not be operable to perform a roll back operation to return to an earlier state. If a network element 108 may perform a roll back operation, abstraction device 106 may instruct the network element 108 to perform the roll back operation when one or more commands in a transaction fail. If network element 108 may not perform a roll back operation, abstraction device 106 may generate one or more “undo” commands for the network element 108. The undo commands instruct network element 108 to perform one or more operations that counteract or mitigate the effect of a command. If network element 108 successfully executes the undo commands, the net effect is that the network element 108 returns to the state it was in before the transaction began. As a particular example, in the bill payment transaction, one command in the transaction may instruct a network element 108 to debit an account by a specified amount. If the network element 108 that will debit the account cannot perform a roll back operation, abstraction device 106 may generate an undo command that instructs the network element 108 to credit the account by the same amount. If a command in the transaction fails, abstraction device 106 may communicate the undo command to network element 108. Network element 108 may then execute the undo command and credit the account. The effect of the undo command is that network element 108 returns to its previous state.

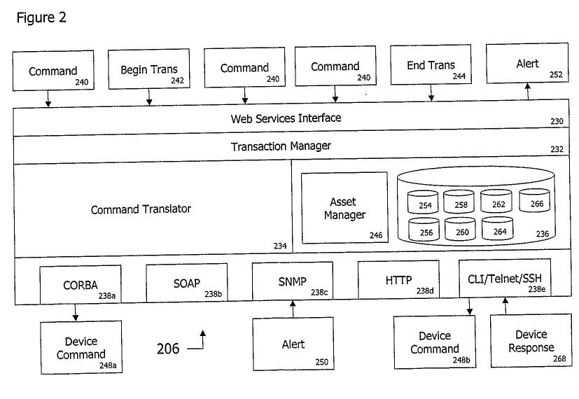

Abstraction device 106 may include any hardware, software, firmware, or combination thereof for facilitating communication between components of system 100. Abstraction device 106 may, for example, include at least one processor 114 and at least one memory 116. Memory 116 may store instructions to be executed by processor 114 to perform the described functions of abstraction device 106. Memory 116 may also store information used by processor 114 to perform the described functions of abstraction device 106, such as information identifying how to translate commands from manager 102 into protocols suitable for use by network elements 108. One embodiment of an abstraction device is shown in FIG. 2, which is described below.

Network element 108 is coupled to at least one abstraction device 106. Network element 108 is operable to perform one or more of a variety of functions in system 100. A network element 108 could, for example, perform routing, switching, load balancing, database maintenance, and/or any other suitable function in system 100.

A network element 108 may communicate and be controlled based on the type of interface 112 used by the network element 108. For example, network elements 108a-108c may communicate using programmatic interfaces 112a-112c, respectively. In the illustrated embodiment, network elements 108a-108c communicate using a Common Object Request Broker Architecture (CORBA) interface 112a, a SOAP interface 112b, and a Simple Network Management Protocol (SNMP) interface 112c, respectively.

Other network elements 108d-108f may not provide a programmatic interface. Some of these network elements, such as network element 108d, may use a command line interface (CLI) 112d to support Telnet, HTTP, SSH and/or other command translation. Other network elements, such as network elements 108e and 108f, may be coupled to abstraction device 106 through a device manager 110. Device manager 110 supports the interface needed to communicate with abstraction device 106. Device manager 110 may also receive information from abstraction device 106 for a specific network element 108, identify the specified network element 108, and communicate the information to the identified network element 108.

Network element 108 may include any hardware, software, firmware, or combination thereof for performing at least one function in system 100. Device manager 110 may include any hardware, software, firmware, or combination thereof for managing one or more network elements 108.

In the illustrated embodiment, system 100 includes multiple abstraction devices 106. In this embodiment, each abstraction device 106 is coupled to each network element 108, either indirectly through a device manager 110 or directly. In a particular embodiment, one of the abstraction devices 106 acts as a primary unit while the other acts as a backup or secondary unit. In this embodiment, the primary abstraction device 106 processes all communications between manager 102 and network elements 108, and the secondary abstraction device 106 takes over if the primary abstraction device 106 fails.

In another embodiment, abstraction devices 106 may operate at the same time, each processing some of the communications between manager 102 and network elements 108. In this embodiment, a load balancer 118 may be coupled between abstraction devices 106 and network 104. Load balancer 118 may, for example, receive multiple commands from manager 102, communicate some of the commands to one abstraction device 106a, and communicate the remaining commands to the other abstraction device 106b. In this way, load balancer 118 may distribute commands from manager 102 to multiple abstraction devices 106, which may reduce the processing load placed on each abstraction device 106.

In yet another embodiment, each abstraction device 106 may serve a subset of network elements 106. For example, one abstraction device 106a may serve network elements 108a-108c, while another abstraction device 106b serves network elements 108d-108f. This also may help to reduce the processing load placed on each abstraction device 106. In still another embodiment, system 100 could have aspects of all three previous embodiments. For example, system 100 could have a group of abstraction devices 106 for each subset of network elements 106. Within each group of abstraction devices 106, some could act as primary units while others act as backup units. Also, one or more load balancers 118 could distribute the load among the active abstraction devices 106 in a group. Other embodiments of system 100 may be used without departing from the scope of the present invention.

Although FIG. 1 illustrates one example embodiment of system 100, various changes may be made to system 100 without departing from the scope of the present invention. For example, any suitable number of managers 102, abstraction devices 106, network element 108, and/or load balancers 118 may be used in system 100. Also, abstraction device 106 may facilitate communication between network elements 108 and any other suitable network component and is not limited to facilitating communication with manager 102. Further, while FIG. 1 illustrates a CORBA device manager 110, any other and/or additional device managers 110 may be used in system 100. In addition, network elements 108 may communicate using any suitable protocols and are not limited to communicating with the CORBA, SOAP, and SNMP protocols. If a network element 108 communicates using the same protocol as manager 102, abstraction device 106 may not need to perform a translation function. Beyond that, FIG. 1 illustrates one example system in which abstraction device 106 may operate. Abstraction device 106 may also operate in any other suitable system and facilitate communication between any other suitable components in the system.

FIG. 2 illustrates an example abstraction device 206 constructed according to the teachings of the present invention. Abstraction device 206 may, for example, be useful as abstraction device 106 in system 100 of FIG. 1. In the illustrated embodiment, abstraction device 206 includes a web services interface 230, a transaction manager 232, a command translator 234, a database 236, and one or more protocol translators 238. Other embodiments of abstraction device 206 may be used without departing from the scope of the present invention.

Web services interface 230 facilitates communication with one or more network components, such as manager 102, using one or more web services protocols. As a particular example, web services interface 230 may receive one or more commands 240 from manager 102 over network 104 using the .NET web services protocol standard. In one embodiment, web services interface 230 may include one or more protocol layers that support a physical interface to network 104, such as one or more layers supporting an ethernet or local area network interface. Web services interface 230 could also include one or more protocol layers allowing abstraction device 206 to communicate XML-encoded information using the SOAP protocol. These protocol layers would allow web services interface 230 to receive XML documents using the SOAP protocol, extract the information contained in the XML documents, and communicate the information to other components of abstraction device 206. These protocol layers would also allow web services interface 230 to receive information, generate XML documents containing the information, and communicate the XML documents using the SOAP protocol. Web services interface 230 may include any hardware, software, firmware, or combination thereof for facilitating communication using one or more web services protocols.

Transaction manager 232 manages the execution of one or more transactions by network elements 108. A transaction may involve the execution of a single command 240 or multiple commands 240 by one or more network elements 108. In one embodiment, a transaction involving multiple commands 240 may be identified with a begin transaction message 242 and an end transaction message 244. The begin transaction message 242 informs transaction manager 232 that multiple commands 240 form part of a single transaction. Transaction manager 232 may treat each command 240 received after the begin transaction message 242 and before the end transaction message 244 as part of a single transaction.

In one embodiment, if one or more commands 240 forming a transaction cannot be executed successfully by one or more network elements 108, transaction manager 232 may treat the entire transaction as having failed. For example, as described below, command translator 234 may generate a sequence of one or more device commands 248 for each command 240 in a transaction. The device commands 248 implement the function requested by a command 240. In a particular embodiment, transaction manager 232 may determine that the failure of one or more device commands 248 to execute successfully indicates that the command 240 associated with the device commands 248 also cannot execute successfully. In that case, transaction manager 232 may determine that the entire transaction has failed. Transaction manager 232 may then instruct one or more network elements 108 to roll back and return to the state that the network elements 108 were in before the beginning of the transaction.

In one embodiment, transaction manager 232 may use information stored in database 236 to determine whether a network element 108 may perform a roll back operation. In this embodiment, if a network element 108 cannot perform roll back operations, transaction manager 232 may generate one or more undo commands associated with the network element 108. In one embodiment, each undo command may counteract the effect of a device command 248 and/or a command 240, although any other suitable undo commands may be used without departing from the scope of the present invention. When transaction manager 232 determines that one or more commands 240 in a transaction have failed to complete successfully, transaction manager 232 may communicate the undo commands to network elements 108.

Although transaction manager 232 has been described as generating one or more undo commands for each network element 108 that cannot perform roll back operations, other embodiments of transaction manager 232 may be used without departing from the scope of the present invention. For example, transaction manager 232 could operate in a system where no network elements 108 can perform roll back operations, so transaction manager 232 could always generate one or more undo commands for each command 240 received by abstraction device 206. Transaction manager 232 could also operate in a system where all network elements 108 can perform roll back operations, and transaction manager 232 would not need to generate undo commands.

In one embodiment, transaction manager 232 may also generate and communicate messages indicating the status of a transaction to manager 102 or other element of system 100. For example, if all of the commands 240 in a transaction execute successfully, transaction manager 232 may inform manager 102 that the transaction is successful. Similarly, if one or more commands 240 in a transaction cannot be executed successfully and network elements 108 are successfully returned to their previous state, transaction manager 232 may inform manager 102 that the transaction failed. When transaction manager 232 informs manager 102 that the transaction failed, transaction manager 232 could include any other suitable information, such as the command 240 that failed to execute and/or the network element 108 that was unable to execute the command 240. In addition, if one or more commands 240 in a transaction failed and one or more network elements 108 were unable to return to their previous state, transaction manager 232 may inform manager 102 that an error exists in system 100. In that case, the transaction cannot be completed successfully in system 100, but at least one network element 108 has successfully changed from its previous state. Manager 102 may then take any suitable corrective action, such as generating a work order and/or an alert identifying the problem.

Transaction manager 232 may include any hardware, software, firmware, or combination thereof for managing one or more transactions. In one embodiment, transaction manager 232 includes one or more software routines stored on memory 116 and executed by processor 114. In another embodiment, abstraction device 206 does not need to perform transaction management functions, and transaction manager 232 may be omitted.

Command translator 234 may receive commands 240 and translate and/or reformat commands 240 into one or more device commands 248 suitable for use by network elements 108. For example, command translator 234 may receive a command 240, access database 236 and/or an asset manager 246, and identify the network element 108 associated with command 240. Command translator 234 may also access database 236 and identify one or more device commands 248a and 248b (referred to collectively as device commands 248) that invoke the function requested by command 240 in the identified network element or elements 108. Command translator 234 may further use the information stored in database 236 to map information contained in command 240 into the appropriate positions or fields in device commands 248. In addition, command translator 234 may communicate each device command 248 to a protocol converter 238 that communicates with a network element 108 using the appropriate protocol. In this manner, command translator 234 may receive a command 240 from manager 102 or other element of system 100, translate the command 240 into one or more device commands 248, and communicate the device commands 248 to one or more network elements 108.

In one embodiment, command translator 234 may also receive information generated by one or more network elements 108, such as an alert 250 generated by a network element 108. The alert 250 may, for example, indicate that a hard drive of network element 108 will fail within a given time period. Command translator 234 may receive the alert 250, use the information in database 236 to generate a message 252 for manager 102, and communicate the message 252 to manager 102. In this manner, command translator 234 may facilitate bidirectional communication between manager 102 and network elements 108. However, command translator 234 could also facilitate unidirectional communication between manager 102 and network elements 108 without departing from the scope of the present invention.

Command translator 234 may include any hardware, software, firmware, or combination thereof for translating commands from one format to at least one other format. Command translator 234 may, for example, include one or more software routines stored in memory 116 and executed by processor 114.

Database 236 stores and facilitates retrieval of information used by abstraction device 206 to perform command translation and other functions. Database 236 may include any of a variety of data structures, arrangements, and/or compilations suitable to store and facilitate retrieval of information. Although FIG. 2 illustrates database 236 as residing within abstraction device 206, database 236 may reside in any suitable location or locations accessible by abstraction device 206. Database 236 may include any hardware, software, firmware, or combination thereof suitable to store and facilitate retrieval of information. Database 236 may store any suitable information used by abstraction device 206 to perform command translation or other functions. The following examples are for illustration only. Any other and/or additional types of information may be used without departing from the scope of the present invention.

In one embodiment, database 236 stores device information 254. In a particular embodiment, device information 254 identifies each network element 108 in system 100 and the device type of each network element 108. For example, each network element 108 may communicate using at least one communications protocol, and network elements 108 may be divided into groups or device types based on the communications protocol used by network elements 108. As particular examples, network elements 108 may be divided into CORBA elements, SOAP elements, SNMP elements, HTTP elements, and CLI elements. In this embodiment, device information 254 may identify the device type of each network element 108 in system 100. Device information 254 could store any other information about network elements 108, such as whether a network element 108 can perform a roll back operation.

Database 236 may also store device type information 256. Device type information 256 may, for example, identify each device type in system 100, the communications protocol used by each of the device types, and any other suitable information about the device types. In one aspect of operation, command translator 234 may receive a command 240 and identify the network element 108 associated with command 240. Using the identity of the network element 108, command translator 234 may access device information 254 and identify the device type of the network element 108. Command translator 234 may also access device type information 256 and identify the communications protocol to be used to communicate with the network element 108. After command translator has generated one or more device commands 248 for network element 108, command translator 234 may communicate the device commands 248 to the protocol converter 238 that supports the communications protocol used by network element 108.

Database 236 may further store command sequence information 258. Command sequence information 258 identifies a sequence of one or more device commands 248 associated with a command 240 that may be received from manager 102 or other element of system 100. For example, for a given command 240, command sequence information 258 may identify the sequence of device commands 248 used to invoke the function requested by command 240. As a particular example, a command 240 may instruct a network element 108 to add a Virtual Internet Protocol (VIP) address to a sub-network in system 100. Command sequence information 258 may indicate that the “Add VIP” command 240 may be implemented by a network element 108 using two device commands 248. One of the device commands 248 may cause the network element 108 to provision the sub-network in system 100, while the other device command 248 instructs the network element 108 to assign the VIP address to the provisioned sub-network. In one aspect of operation, command translator 234 may receive a command 240, access command sequence information 258, and identify the one or more device commands 248 used to implement the command 240. The specific sequence of device commands 248 used to implement a command 240 may vary depending on the network element 108 associated with command 240, the device type of the network element 108 associated with command 240, and/or in any other suitable manner. In a particular embodiment, command sequence information 258 could identify multiple sequences of device commands 248 for a single command 240. Each sequence may be associated with a different network element 108 or device type. In this embodiment, command translator 234 may select the specific sequence of device commands 248 based on the identity of the network element 108 and/or the device type of network element 108.

Database 236 may also store control instruction information 260 and script instruction information 262. Control instruction information 260 and script instruction information 262 identify how to format device commands 248 for network elements 108. For example, in one embodiment, each device command 248 includes one or more fields containing information used by a network element 108 to implement or invoke a function. In this embodiment, control instruction information 260 may identify the fields used in a device command 248 that will be sent to a network element 108 having a programmatic interface 112. Script instruction information 262 may identify the fields used in a device command 248 that will be sent to a network element 108 having a command line interface 112d. Script instruction information 262 may also identify the format of command line responses 268, or responses to the device commands 248 communicated over the command line interface 112d. In one aspect of operation, after command translator 234 identifies the sequence of device commands 248 used to implement a command 240, command translator 234 may use control instruction information 260 and/or script instruction information 262 to identify the fields contained in the identified device commands 248. This allows command translator 234 to generate device commands 248 having the proper format and that can be understood by network elements 108.

Database 236 may further store field mapping information 264. Field mapping information 264 identifies how to map information from commands 240 to the fields of device commands 248. For example, field mapping information 264 may identify how to extract information from a command 240 and where to store that information in a device command 248. Field mapping information 264 may also identify how to extract information contained in a command line response 268 and store some or all of that information in a message for manager 102. Field mapping information 264 may further identify whether the information extracted from command 240 or command line response 268 needs to be translated and/or reformatted before being stored in a device command 248 or message 252. In one aspect of operation, after identifying the device commands 248 and the fields of the device commands 248, command translator 234 may use field mapping information 264 to extract information contained in command 240 and store some or all of that information in the appropriate fields of device commands 248. This generates device commands 248 having the information needed to invoke functions in one or more network elements 108.

In addition, database 236 may include registration information 266. In one embodiment, the web services protocol used in system 100 supports the “publication” of information about a web service. For example, the publication may include making information available that identifies the existence of the web service, the function provided by the web service, and how to invoke the web service. This information may be made available to manager 102, other network components, other web services, a web services registry, and/or any other suitable entity. In this embodiment, network elements 108 may be managed as a web service. Registration information 266 may identify each network element 108 and how to invoke features or functions of network elements 108. In a particular embodiment, registration information 266 includes information used by a Universal Description, Discovery and Integration (UDDI) registry in system 100, which stores information about various web services in one or more directories. Registration information 266 may also include Web Services Description Language (WSDL) information identifying how to format requests to a network element 108. In this embodiment, web services interface 230 may further support the use of the UDDI and WSDL protocols, such as through the use of one or more protocol layers supporting the protocols.

Protocol converter 238 may receive a device command 248 from command translator 234 and convert the device command 248 from the protocol used by command translator 234 into the protocol used by a network element 108. For example, command translator 234 may communicate information to protocol converter 238 using a COM+ protocol or JAVA protocol, although any other suitable protocol may be used without departing from the scope of the present invention. A protocol converter 238a-238c may then convert the information from command translator 234 into another protocol, such as the CORBA, SOAP, and SNMP protocols, used by network element 108. A protocol converter 238d could also convert the information from command translator 234 into a format suitable for use with a command link interface 112d. Protocol converter 238 could further receive information from network element 108, such as alert 250, and convert the information into a protocol suitable for use by command translator 234. Protocol converter 238 may include any hardware, software, firmware, or combination thereof for converting information between protocols. Although FIG. 2 illustrates abstraction device 206 as including four protocol converters 238, any number of protocol converters 238 may be used in abstraction device 206.

Abstraction device 206 may further include an asset manager 246. Asset manager 246 allows abstraction device 206 to identify one or more network elements 108 associated with a command 240. For example, asset manager 246 may identify one or more network elements 108 that are to perform the function requested by command 240. In one embodiment, asset manager 246 and/or database 236 may store information used to identify various network elements 108 in system 100. This information may, for example, include a logical name and a network address, such as an Internet Protocol (IP) address, for each network element 108. When abstraction device 206 receives a command 240, asset manager 246 may identify the network element 108 associated with the command 240 using this and/or other information. Abstraction device 206 may then generate one or more device commands 248 for the identified network element 108. In another embodiment, abstraction device 206 does not include asset manager 246. In this embodiment, a command 240 received by abstraction device 206 may include information identifying at least one network element 108 associated with the command 240. Abstraction device 206 may use the information in command 240 to identify the network element 108 associated with command 240. While FIG. 2 illustrates asset manager 246 as a separate element of abstraction device 206, asset manager 246 could be combined with another element of abstraction device 206 without departing from the scope of the present invention.

In one embodiment, the UDDI, WSDL, and/or other protocols supported by abstraction device 206 may further support the auto-discovery and auto-registration of network elements 108 with abstraction device 206. For example, when a new network element 108 is added to system 100, abstraction device 206 could detect the new network element 108. As a particular example, abstraction device 206 could poll network elements 108 and identify the new network element 108. Once abstraction device 206 identifies the presence of the new network element 108, abstraction device 206 may communicate with the new network element 108 and receive information about the new network element 108. For example, the new network element 108 may inform abstraction device 206 of the functions performed by network element 108 and how to invoke the functions in the network element 108. Abstraction device 206 may then update registration information 266 with the information.

Although FIG. 2 illustrates one embodiment of abstraction device 206, various changes may be made to abstraction device 206 without departing from the scope of the present invention. For example, abstraction device 206 may include any number of protocol converters 238. Also, abstraction device 206 need not include a transaction manager 232 and/or an asset manager 246. Further, the functional divisions of abstraction device 206 are for illustration only. Various functional components of abstraction device 206 could be added, combined with one another, or removed from abstraction device 206, depending on particular needs, without departing from the scope of the present invention. In addition, the functions in abstraction device 206 may be implemented using any hardware, software, firmware, or combination thereof. This may include, for example, logic stored in any suitable device, such as a random access memory, a read-only memory, an application-specific integrated circuit (ASIC), or a field programmable gate array (FPGA).

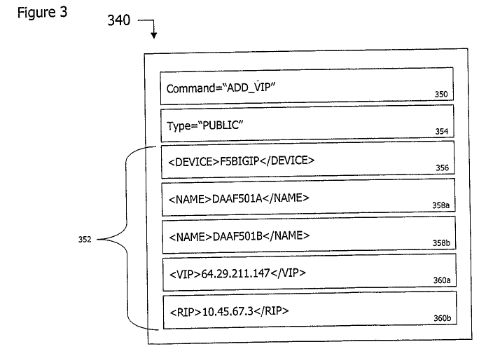

FIG. 3 illustrates an example network command 340 according to the teachings of the present invention. Command 340 may, for example, be useful as command 240 in FIG. 2. In the illustrated embodiment, command 340 includes an instruction 350, identification information 352, and additional information 354. Other embodiments of command 340 may be used without departing from the scope of the present invention. Also, while command 340 may be described as being processed by abstraction device 206 of FIG. 2, command 340 could also be received and processed by abstraction device 106 of FIG. 1 and/or any other suitable device.

Instruction 350 identifies the function requested by command 340. In the illustrated embodiment, instruction 350 requests that a new VIP address be added in system 100. However, command 340 could request any other suitable function that may be performed by one or multiple network elements 108.

Identification information 352 identifies the one or more network elements 108 associated with command 340. In the illustrated embodiment, identification information 352 includes one or more device identifiers 356, one or more name identifiers 358, and one or more network addresses 360. Device identifier 356 may identify the specific component forming a network element 108. For example, the device identifier “F5” may refer to a load balancer manufactured by F5 NETWORKS, INC. of Seattle, Wash. Name identifier 358 may identify the logical name assigned to a network element 108. Network address 360 may identify the network address used to communicate with the network element 108 in system 100. Other and/or additional information may be included in identification information 352 without departing from the scope of the present invention.

Identification information 352 may be useful, for example, when abstraction device 206 lacks an asset manager 246. In this embodiment, identification information 352 allows abstraction device 206 to identify at least one network element 108 associated with command 340. In another embodiment, abstraction device 206 may include an asset manager 246. In this embodiment, identification information 352 could include less information. For example, in a particular embodiment, identification information 352 could include only one or more name identifiers 358.

Additional information 354 may represent any other information included in command 340 and/or used by abstraction device 206. Additional information 354 may include one or multiple pieces of information, depending on the command 340, the function being invoked by command 340, and/or any other suitable criteria. Also, additional information 354 could be omitted in command 340.

Although FIG. 3 illustrates one example of a command 340, various changes may be made to command 340 without departing from the scope of the present invention. For example, command 340 may include any suitable information and invoke any suitable function or feature in system 100.

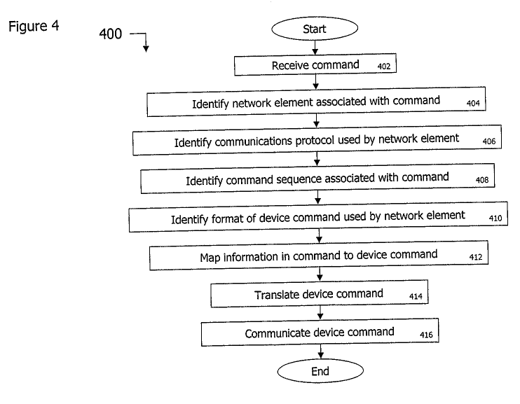

FIG. 4 illustrates an example method 400 for facilitating communication with network elements 108 according to the teachings of the present invention. While method 400 is described with respect to abstraction device 206 of FIG. 2, method 400 could be used by abstraction device 106 of FIG. 1 and/or any other suitable device. Also, while method 400 is described as facilitating communication between manager 102 and network elements 108, method 400 may be used to facilitate communication between network elements 108 and any other suitable component.

Abstraction device 206 receives a command 240 at step 402. This may include, for example, web services interface 230 receiving the command 240 over network 104. The command 240 may be received using a web services protocol. Abstraction device 206 identifies one or more network elements 108 associated with the command 240 at step 404. This may include, for example, command translator 234 and/or asset manager 246 using identification information 352 in command 240 to identify the one or more network elements 108. Abstraction device 206 identifies the communications protocol used by the identified network element 108 at step 406. This may include, for example, command translator 234 using device information 254 and/or device type information 256 in database 236 to identify the communications protocol.

Abstraction device 206 identifies a command sequence associated with the command 240 at step 408. This may include, for example, command translator 234 accessing command sequence information 258 in database 236. This may also include command translator 234 selecting one of a plurality of command sequences associated with command 240, such as by selecting a command sequence based on the identity of the network element 108 associated with command 240. The selected command sequence may represent one or more device commands 248 that will implement the function requested by command 240.

Abstraction device 206 identifies the format of the one or more device commands 248 at step 410. This may include, for example, command translator 234 accessing control instruction information 260 and/or script instruction information 262 in database 236. If a network element 108 receiving a device command 248 has a programmatic interface 112, such as a CORBA, SOAP, or SNMP interface 112a-112c, command translator 234 may use control instruction information 260. If a network element 108 receiving a device command 248 uses a command line interface 112d, command translator 234 may use script instruction information 262.

Abstraction device 206 maps information contained in command 240 into one or more fields of the identified device command 248 at step 412. This may include, for example, command translator 234 accessing field mapping information 264 in database 236. Field mapping information 264 may identify how command translator 234 may map and/or translate information contained in command 240 into the appropriate fields of device command 248.

Abstraction device 206 translates the device command 248 at step 414. This may include, for example, command translator 234 communicating the device command 248 to one of the protocol converters 238. The protocol converter 238 selected may be based, for example, on the communications protocol identified at step 406. This may also include command translator 234 communicating the device command 248 to the protocol converter 238 using a first protocol and the protocol converter 238 translating the device command 248 into a second protocol used by network element 108. As a particular example, a protocol converter 238 may translate a device command 248 from the COM+ protocol used by command translator 234 to the protocol used by network element 108. Abstraction device 206 communicates the translated device command 248 to the network element 108 at step 416. This may include, for example, protocol converter 238 communicating the device command 248 to the network element 108.

Although FIG. 4 illustrates one example of a method 400 for facilitating communication with network elements 108, various changes may be made to method 400 without departing from the scope of the present invention. For example, various steps in method 400 may be rearranged without departing from the scope of the present invention. Also, a network element 108 may communicate using the same protocol used by manager 102 or other component in system 100 that generates the command 240. In this case, abstraction device 206 may not need to perform various steps in method 400 to facilitate communication between manager 102 and network element 108. In addition, a command 240 could be associated with a command sequence having any number of device commands 248 and involve any number of network elements 108.

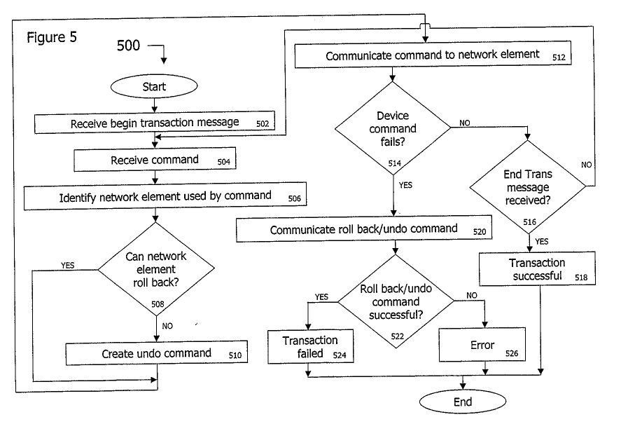

FIG. 5 illustrates an example method 500 for managing a transaction according to the teachings of the present invention. Although method 500 may be described with respect to abstraction device 206 of FIG. 2, method 500 could be used by abstraction device 106 of FIG. 1 and/or any other suitable device. Also, method 500 may be described as managing a transaction involving multiple commands 240 and involving multiple network elements 108. A transaction could include any number of commands 240 and/or involve any number of network elements 108.

Abstraction device 206 receives a begin transaction message 242 at step 502. This may include, for example, abstraction device 206 receiving the begin transaction message 242 through web services interface 230. The begin transaction message 242 indicates that multiple commands 240 following the begin transaction message 242 belong to the same transaction. Abstraction device 206 receives a command 240 in a transaction at step 504. This may include, for example, abstraction device 206 receiving the command 240 through web services interface 230.

Abstraction device 206 identifies the network elements 108 associated with the command 240 at step 506. This may include, for example, transaction manager 232, command translator 234, and/or asset manager 246 identifying one or more network elements 108 associated with command 240 using identification information 352 in command 240. Abstraction device 206 determines whether the network element 108 associated with command 240 can perform a roll back operation at step 508. This may include, for example, transaction manage 232 accessing device information 254 in database 236 and determining whether the network element 108 can perform a roll back operation. If the network element 108 cannot perform a roll back operation, abstraction device 206 creates one or more undo commands for the network element 108 at step 510. This may include, for example, transaction manager 232 generating an undo command that counteracts or mitigates the effect of each device command 248 associated with command 240.

Abstraction device 206 communicates one or more device commands 248 to network element 108 at step 512. This may include abstraction device 206 receiving a response from network elements 108 for each device command 248 identifying whether the device command 248 executed successfully. Abstraction device 206 determines whether any of the device commands 248 failed to execute successfully at step 514. This may include, for example, transaction manager 232 examining the responses from network element 108 and determining whether network element 108 was unable to successfully execute a device command 248.

If none of the device commands 248 failed, abstraction device 206 may determine whether an end transaction message 244 has been received at step 516. The end transaction message 244 indicates that the last command 240 in a transaction has been received. If an end transaction message 244 is received, abstraction device 206 determines that the transaction was successful at step 518. At this point, all of the commands 240 in the transaction have executed successfully, and no more commands 240 in the transaction need to be executed. Abstraction device 206 may take any suitable action, such as informing manager 102 that the transaction executed successfully.

If an end transaction message 244 is not received at step 516, abstraction device 206 returns to step 504. At this point, another command 240 in the transaction may be received and processed by abstraction device 206.

If one or more of the device commands 248 failed to execute successfully at step 514, abstraction device 206 communicates one or more roll back and/or undo commands to at least one network element 108 at step 520. This may include, for example, transaction manager 232 communicating a roll back or undo command to each network element 108 that received and successfully executed a device command 248. These network elements 108 may no longer be in the state that existed before the transaction began. Abstraction device 206 determines whether all of the roll back and/or undo commands were executed successfully at step 522. This may include, for example, transaction manager 232 reviewing any responses from the network elements 108 that receive the roll back and/or undo commands. If all of the roll back and/or undo commands were executed successfully by network elements 108, abstraction device 206 informs manager 102 that the transaction failed at step 524. In this case, one or more commands 240 in the transaction could not be executed successfully, and network elements 108 have been returned to the state they were in before the transaction began. Otherwise, at least one of the roll back and/or undo commands was not executed successfully by a network element 108. In this case, abstraction device 206 informs manager 102 that an error may exist in system 100 at step 526. In particular, the transaction cannot be completed successfully, but at least one network element 108 cannot be returned to its previous state. Abstraction device 206 and/or manager 102 may then take any suitable corrective action, such as by generating a work order and/or communicating an alert to a user of system 100.

Although FIG. 5 illustrates one example of a method 500 for managing a transaction, various changes may be made to method 500 without departing from the scope of the present invention. For example, the transaction may involve any suitable number of commands 240 and/or any suitable number of network elements 108. Also, abstraction device 206 could be used in a system where all network elements 108 can or cannot perform a roll back operation. If all network elements 108 can perform a roll back operation, abstraction device 206 could skip steps 506 and 508. If no network element 108 can perform a roll back operation, abstraction device could skip step 506.

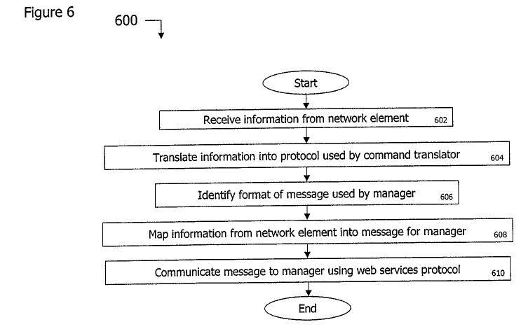

FIG. 6 illustrates an example method 600 for facilitating communication with manager 102 according to the teachings of the present invention. Although method 600 is described with respect to abstraction device 206 of FIG. 2, method 600 could also be used by abstraction device 106 of FIG. 1 and/or any other suitable device.

Abstraction device 206 receives information from a network element 108 at step 602. This may include, for example, a protocol converter 238 receiving an alert message 250 from a network element 108. Abstraction device 206 translates the information from network element 108 into a protocol used by command translator 234 at step 604. This may include, for example, protocol converter 238 converting the information from network element 108 into the COM+ protocol used by command translator 234, although other protocols may be used without departing from the scope of the present invention.

Abstraction device 206 identifies the format of a message 252 used by manager 102 at step 606. This may include, for example, command translator 234 using the information in database 236 to identify the fields contained in a message 252 that can be understood by manager 102. Abstraction device 206 maps the information from network element 108 into the message 252 for manager 102 at step 608. This may include, for example, command translator 234 placing the information from network element 108 into the appropriate fields of the message 252 for manager 102. Abstraction device 206 communicates the message 252 to manager 102 using a web services protocol at step 610. This may include, for example, command translator 234 communicating the message 252 to web services interface 230. This may also include web services interface 230 formatting the message 252 into the proper format and communicating the message 252 to manager 102 using the web services protocol. In a particular embodiment, the web services protocol includes the .NET protocol.

Although FIG. 6 illustrates one example of a method 600 for facilitating communication with a manager 102, various changes may be made to method 600 without departing from the scope of the present invention. For example, method 600 may be used to facilitate communication with any network component and is not limited to facilitating communication with manager 102. Also, if the network element 108 uses the same protocol as manager 102, abstraction device 206 may not need to perform some of the steps of method 600.

Although the present invention has been described with several embodiments, a number of changes, substitutions, variations, alterations, and modifications may be suggested to one skilled in the art, and it is intended that the invention encompass all such changes, substitutions, variations, alterations, and modifications that fall within the spirit and scope of the appended claims. It should be understood that various changes and modifications to the presently preferred embodiments described herein will be apparent to those skilled in the art. Such changes and modifications can be made without departing from the spirit and scope of the present invention and without diminishing its intended advantages. It is therefore intended that such changes and modifications be covered by the appended claims.

The invention is claimed as follows:

1. An apparatus for facilitating communication in a network, comprising:
a web services interface operable to communicate over a network and receive a command using a web services protocol;
a command translator operable to receive the command and generate at least one device command corresponding to the command, the at least one device command operable to invoke one or more functions in at least one network element; and
a plurality of protocol converters each operable to receive at least one device command, translate the at least one device command from a first protocol to a second protocol, and communicate the at least one device command to one or more network elements, at least two of the protocol converters operable to translate the at least one device command into different second protocols.

2. The apparatus of claim 1, further comprising a transaction manager operable to manage execution of a transaction, the transaction comprising the command.

3. The apparatus of claim 2, wherein the transaction manager is operable to manage execution of the transaction by:
monitoring execution of the at least one device command by one or more network elements; and
determining whether any of the at least one device command failed to execute successfully.

4. The apparatus of claim 3, wherein the transaction manager is further operable to manage execution of the transaction by:
generating one or more of at least one of a roll back command and an undo command; and
communicating the at least one of the roll back command and the undo command to one or more network elements when at least one device command fails to execute successfully.

5. The apparatus of claim 2, wherein:
the command comprises one of a plurality of commands in the transaction;
the web services interface is further operable to receive a begin transaction message and an end transaction message; and
the plurality of commands forming the transaction are received after the begin transaction message and before the end transaction message.

6. The apparatus of claim 1, wherein the command translator is operable to generate the at least one device command corresponding to the command by:
identifying a command sequence associated with the command, the command sequence comprising the at least one device command;
identifying one or more fields in the at least one device command; and
mapping at least a portion of the information contained in the command into at least some of the one or more fields in the at least one device command.

7. The apparatus of claim 6, wherein the command translator is operable to identify a command sequence associated with the command by selecting one of a plurality of command sequences associated with the command.

8. The apparatus of claim 1, further comprising an asset manager operable to identify the at least one network element associated with the command using information contained in the command.

9. The apparatus of claim 1, wherein:
at least one of the protocol converters is further operable to receive information from at least one of the network elements, translate the information from one of the second protocols to the first protocol, and communicate the information to the command translator;
the command translator is further operable to receive the information from the network element and generate a message containing the information; and
the web services interface is further operable to communicate the message over the network.

10. The apparatus of claim 9, wherein the web services interface receives the command and communicates the message to a network manager coupled to the network.

11. The apparatus of claim 1, wherein:
at least one of the protocol converters is further operable to receive registration information from a network element, the registration information identifying how to invoke a function of the network element; and
the web services interface is further operable to publish the registration information.

12. The apparatus of claim 11, wherein the registration information comprises at least one of Universal Description, Discovery and Integration (UDDI) information and Web Services Description Language (WSDL) information.

13. The apparatus of claim 1, wherein the web services protocol comprises a .NET protocol.

14. The apparatus of claim 1, wherein the first protocol comprises a COM+ protocol.

15. The apparatus of claim 1, wherein each of the plurality of protocol converters is operable to translate the at least one device command from the first protocol to at least one of a Common Object Request Broker Architecture protocol, a Simple Object Access Protocol, a Simple Network Management Protocol, and a Command Line Interface protocol.

16. An apparatus for facilitating communication in a network, comprising:
a memory operable to store an identification of one or more first communications protocols used by each of a plurality of network elements, at least two of the network elements using one or more different first communications protocols; and
one or more processors collectively operable to:
receive a command using a web services protocol;
generate at least one device command corresponding to the command, the at least one device command operable to invoke one or more functions in at least one network element;
identify at least one first communications protocol associated with the at least one network element;
translate the at least one device command from a second communications protocol to the at least one first communications protocol; and
communicate the at least one device command to the at least one network element.

17. The apparatus of claim 16, wherein the one or more processors are further collectively operable to manage execution of a transaction, the transaction comprising the command.

18. The apparatus of claim 17, wherein the one or more processors are collectively operable to manage execution of the transaction by:
monitoring execution of the at least one device command by one or more network elements;
determining whether any of the at least one device command failed to execute successfully;
generating one or more of at least one of a roll back command and an undo command; and
communicating the at least one of the roll back command and the undo command to one or more network elements when at least one device command fails to execute successfully.

19. The apparatus of claim 17, wherein:
the command comprises one of a plurality of commands in the transaction;
the one or more processors are further collectively operable to receive a begin transaction message and an end transaction message; and
the plurality of commands forming the transaction are received after the begin transaction message and before the end transaction message.

20. The apparatus of claim 16, wherein the one or more processors are collectively operable to generate the at least one device command corresponding to the command by:
identifying a command sequence associated with the command, the command sequence comprising the at least one device command;
identifying one or more fields in the at least one device command; and
mapping at least a portion of the information contained in the command into at least some of the one or more fields in the at least one device command.

21. The apparatus of claim 16, wherein the one or more processors are further collectively operable to identify the at least one network element associated with the command using information contained in the command.

22. The apparatus of claim 16, wherein the one or more processors are further collectively operable to receive information from at least one of the network elements, translate the information from one of the first communications protocols to the second communications protocol, generate a message containing the information, and communicate the message over the network.

23. The apparatus of claim 16, wherein the one or more processors are further collectively operable to receive registration information from a network element and publish the registration information, the registration information identifying how to invoke a function of the network element.

24. The apparatus of claim 23, wherein the registration information comprises at least one of Universal Description, Discovery and Integration (UDDI) information and Web Services Description Language (WSDL) information.

25. The apparatus of claim 16, wherein:
the web services protocol comprises a .NET protocol;
the first protocols comprise at least two of a Common Object Request Broker Architecture protocol, a Simple Object Access Protocol, a Simple Network Management Protocol, and a Command Line Interface protocol; and
the second protocol comprises a COM+ protocol.

26. A method for facilitating communication in a network, comprising:
receiving a command using a web services protocol;
generating at least one device command corresponding to the command, the at least one device command operable to invoke one or more functions in at least one network element;
translating the at least one device command from a first protocol to at least one of a plurality of second protocols; and
communicating the at least one device command to one or more network elements.

27. The method of claim 26, further comprising managing execution of a transaction, the transaction comprising the command.

28. The method of claim 27, wherein managing execution of the transaction comprises:
monitoring execution of the at least one device command by one or more network elements;
determining whether any of the at least one device command failed to execute successfully;
generating one or more of at least one of a roll back command and an undo command; and
communicating the at least one of the roll back command and the undo command to one or more network elements when at least one device command fails to execute successfully.

29. The method of claim 27, wherein the command comprises one of a plurality of commands in the transaction; and
further comprising receiving a begin transaction message and an end transaction message, the plurality of commands forming the transaction received after the begin transaction message and before the end transaction message.

30. The method of claim 26, wherein generating the at least one device command corresponding to the command comprises:
identifying a command sequence associated with the command, the command sequence comprising the at least one device command;
identifying one or more fields in the at least one device command; and
mapping at least a portion of the information contained in the command into at least some of the one or more fields in the at least one device command.

31. The method of claim 26, further comprising identifying the at least one network element associated with the command using information contained in the command.

32. The method of claim 26, further comprising:
receiving information from at least one of the network elements;
translating the information from one of the first communications protocols to the second communications protocol;
generating a message containing the information; and
communicating the message over the network.

33. The method of claim 26, further comprising:
receiving registration information from a network element, the registration information identifying how to invoke a function of the network element; and
publishing the registration information.

34. The method of claim 33, wherein the registration information comprises at least one of Universal Description, Discovery and Integration (UDDI) information and Web Services Description Language (WSDL) information.

35. The method of claim 26, wherein:
the web services protocol comprises a .NET protocol;
the first protocols comprise at least two of a Common Object Request Broker Architecture protocol, a Simple Object Access Protocol, a Simple Network Management Protocol, and a Command Line Interface protocol; and
the second protocol comprises a COM+ protocol.

36. Software for facilitating communication in a network, the software embodied on at least one computer readable medium and operable when executed by one or more processors to:
receive a command using a web services protocol;
generate at least one device command corresponding to the command, the at least one device command operable to invoke one or more functions in at least one network element;
translate the at least one device command from a first protocol to at least one of a plurality of second protocols; and
communicate the at least one device command to one or more network elements.

37. A system for facilitating communication in a network, comprising:
means for receiving a command using a web services protocol;
means for generating at least one device command corresponding to the command, the at least one device command operable to invoke one or more functions in at least one network element;
means for translating the at least one device command from a first protocol to at least one of a plurality of second protocols; and
means for communicating the at least one device command to one or more network elements.

38. An apparatus for facilitating communication in a network, comprising:
a plurality of protocol converters each operable to receive information from at least one network element using a first communications protocol and translate the information from the first communications protocol to a second communications protocol, at least two of the protocol converters operable to communicate using different first communications protocols;
a command translator operable to receive the information and generate at least one message containing at least a portion of the information; and
a web services interface operable to receive the message and communicate the message over a network using a web services protocol.

39. An apparatus for facilitating communication in a network, comprising:
a web services interface operable to receive a command using a web services protocol;
a command translator operable to receive the command, identify a command sequence comprising at least one device command associated with the command, identify one or more fields in the at least one device command, and map at least a portion of the information contained in the command into at least some of the one or more fields in the at least one device command, the at least one device command operable to invoke one or more functions in at least one network element;
a plurality of protocol converters each operable to receive at least one device command, translate the at least one device command from a first protocol to a second protocol, and communicate the at least one device command to one or more network elements, at least two of the protocol converters operable to translate the at least one device command into different second protocols; and
a transaction manager operable to monitor execution of the at least one device command by one or more network elements, determine whether any of the at least one device command failed to execute successfully, generate one or more of at least one of a roll back command and an undo command, and communicate the at least one of the roll back command and the undo command to one or more network elements when at least one device command fails to execute successfully.
